(19) United States
(12) Patent Application Publication
(10) Pub. No.: US 2020/0036046 A1
(43) Pub. Date: Jan. 30, 2020

(54) MEMBRANE-FREE NON-FLOWING SINGLE CELL ZINC BROMINE BATTERY WITH BROMINE-TRAPPING COMPOSITE CARBON FOAM ELECTRODE

(71) Applicant: PRINCETON UNIVERSITY, Princeton, NJ (US)

(72) Inventors: Daniel Artemis STEINGART, Princeton, NJ (US); Shaurjo BISWAS, Highland Park, NJ (US); Thomas Matthew HODSON, Liverpool, NY (US); Aoi SENJU, Chappaqua, NY (US); Robert Charles MOHR, Batavia, IL (US)

(73) Assignee: PRINCETON UNIVERSITY, Princeton, NJ (US)

(21) Appl. No.: 16/337,093

(22) PCT Filed: Oct. 11, 2017
(86) PCT No.: PCT/US2017/056035

§ 371 Date: Mar. 27, 2019

Related U.S. Application Data
(60) Provisional application No. 62/406,672, filed on Oct. 11, 2016.

(51) Int. Cl. H01M 10/36; H01M 4/80; H01M 4/66; H01M 10/52

(52) U.S. Cl. CPC H01M 10/365; H01M 4/808; H01M 2004/021; H01M 4/668; H01M 10/526; H01M 4/663

(57) ABSTRACT

Systems and methods pertain to minimal architecture zinc-bromine battery (MA-ZBB) designs which include a conductive carbon foam electrode disposed in a zinc-bromine electrolyte. The foam electrode generates and stores liquid bromine during a charging cycle of battery. A carbon cloth suspended in the electrolyte forms a zinc electrode. A self-discharge behavior of liquid bromine released from the foam electrode attacks any dendritic zinc creeping towards the foam electrode to create a self-discharging function for increased lifetime of the battery. The zinc-bromine battery does not include complexing agents, pumps and membranes, thus reducing cost and failure points and leading to a minimal architecture. Imaging techniques based on distinct colors associated with different concentrations of liquid bromine in the electrolyte are employed to detect battery operation and improve performance.

### CROSS-REFERENCE TO RELATED APPLICATIONS

The present Application for Patent claims the benefit of Provisional Patent Application No. 62/406,672 entitled “MEMBRANE-FREE NON-FLOWING SINGLE CELL ZINC BROMINE BATTERY WITH BROMINE-TRAPPING COMPOSITE CARBON FOAM ELECTRODE” filed Oct. 11, 2016, pending, and assigned to the assignee hereof and hereby expressly incorporated herein by reference in its entirety.

### FIELD OF DISCLOSURE

Disclosed aspects are directed to a membrane-free minimal architecture zinc bromine battery (hereinafter, “MA-ZBB”) with a bromine-trapping composite carbon foam electrode, and to methods for forming the electrodes thereof. Exemplary aspects are also directed to techniques for tracking and improving performance of exemplary batteries.

### BACKGROUND

There is growing need for modernization of grid-scale energy generation, distribution, and storage systems for meeting the energy demands and requirements of the world today. There is also a corresponding need for addressing climate change by integrating more energy from renewable sources and improving utilization and efficiency of non-renewable energy processes. Advances in electric grids for supplying power also face growing requirements for maintaining a robust and resilient electricity delivery system. To address the above needs, energy storage systems are seen to play a significant role, by improving the operating capabilities of the electric grids, lowering cost and ensuring high reliability. Cheap, reliable, and scalable electrochemical energy storage systems are recognized as being instrumental for meeting the above needs, as well as for satisfying additional goals, such as, emergency preparedness in the form of providing backup power and grid stabilization.

Significant progress has been made in grid-scale implementation of renewable energy generation in recent years. While conventional energy transmission and distribution systems are responsible for moving electricity over distances to end users, they are not capable of handling either excess energy or energy deficits. Accordingly, there is a need for deploying battery systems for filling the gap between energy generation and transmission/distribution, in order to store energy and provide electricity when needed. However, conventional energy storage systems are seen to be cost prohibitive, and moreover, there are relatively few existing storage installations in this field.

Energy storage technologies available for large-scale applications can be divided into four types: mechanical, electrical, chemical, and electrochemical. Pumped hydroelectric systems account for 99% of a presently understood worldwide storage capacity of 127,000 megawatts (MW) of discharge power. Compressed air storage is a distant second, at 440 MW. However, these energy storage methods are not widely and abundantly available, and moreover, they are also not scalable. As such, it is recognized that electrochemical energy storage in the form of batteries offers the best solution for energy storage, moving forward.

For large scale batteries to be competitive and a viable solution for the energy storage needs noted above, the following characteristics of batteries are recognized as being desirable: being long lasting; having low costs of production, operation and maintenance; and being scalable. Known battery technologies and implementations thereof are not seen to have the above characteristics to make their use feasible in the above-noted energy storage needs.

Among known efforts for developing batteries which satisfy the above characteristics, engineering zinc-bromine batteries are notable. Such efforts are mainly focused on flow-batteries. Zinc and bromine are both earth abundant materials. Some implementations of zinc-bromine (Zn—Br₂) battery systems may comprise a zinc anode and a bromine cathode, and can operate at considerable power densities (e.g., greater than 100 mW/cm²). Notwithstanding minor manufacturing variations, the zinc-bromine battery chemistry is also known to display considerable energy density (e.g., theoretically greater than 400 Wh/kg). However, problems such as a balance of plant in stabilizing the shape change of a zinc electrode in the zinc-bromine battery, balance of reactions between the anode and cathode of the zinc-bromine battery, etc., have impeded implementation efforts for cost effective zinc-bromine battery systems.

Although zinc-bromine batteries in their deployment as secondary batteries have been studied as a low cost, fully rechargeable, high power and energy density (e.g., greater than 100 mW/cm² and 400 Wh/kg, respectively) energy storage system for a long time, large scale and widespread practical implementation of this battery technology has been retarded due to two key limitations: the characteristics of elemental bromine in liquid state, Br₂(l), generated during the charging cycle to convect and diffuse through the aqueous zinc bromide electrolyte used in the zinc-bromine battery and to react with zinc deposited on the anode of the battery, thus self-discharging the battery; and the repeated electroplating and dissolution of zinc during charging/discharging of the battery, which leads to dendrite formations which grow to eventually form a conductive bridge from the anode to the cathode, effectively shorting the battery. Zinc-bromine flow-cell technologies attempt to alleviate these limitations by adding bromine complexing agents, electrode separating membranes, and flowing electrolyte in an effort to improve zinc plating, but these attempts come at the cost of decreased battery efficiency, and increased cell resistance, size, and capital costs.

Furthermore, conventional zinc-bromine batteries also face known challenges within a secondary zinc anode of the batteries. A corrosion reaction in the zinc-bromine batteries, which may be represented by the equation, Zn(s)+2H⁺(aq)→Zn²⁺+H₂(g), is seen to be thermodynamically favorable. However, the kinetics of such a corrosion reaction are relatively slow compared to the kinetics of zinc deposition. This means that zinc can be plated in low pH conditions with industrially-sufficient current coulombic efficiencies of greater than 90%, as long as small amounts of hydrogen gas generated during operation, which is a potential safety hazard, can be recombined within the battery or safely vented. Another challenge to known implementations of the zinc anode is the above-noted growth of inevitable ramified or dendritic morphologies, as opposed to flat stripping and deposition. Known approaches have exploited the tendency of such dendritic growth on the zinc anode to purposefully create nanostructured dendrites which appear as predictable forms at a micron/battery separator length scale. In all known implementations, however, the eventual roughening of the surface of the zinc anode can lead to short circuits, which can cause runaway heating. The runaway heating may be seen in many known implementations, expect, for example, in so called flooded flow systems which have an excess of electrolyte in the zinc-bromine battery, wherein excess water, in which the electrolyte is dissolved, acts as a thermal sink to protect against overheating. However, even in such flooded flow zinc-bromine batteries, the zinc dendrites may eventually puncture the separator, allowing too much crossover of elemental bromine (Br₂(l)) to sustain standard operation of the zinc-bromine battery.

Implementations involving a flowing bromine cathode have also been explored for zinc-bromine batteries, because bromine is a low cost earth abundant oxidant found naturally as bromide salts in oceans and saltwater lakes. However, despite having a greater oxidizing potential than oxygen (O₂(g)), the reversible conversion of bromide to bromine is kinetically favorable to the formation of oxygen. Thus like the zinc/hydrogen, bromine will form with near unity coulombic efficiency in electrowinning operations instead of O₂ (g). Despite the low raw material cost of bromine, there are challenges of traditional and newer implementations of the flowing bromine cathode, which have kept the price of bromine bearing batteries relatively high. Pure bromine is a known toxin and as a strong oxidant it must be handled carefully when flowing from a tank holding the bromine to a reactor implementing the battery, to avoid corrosion of the operation structures, in addition to effluence.

Beyond the safety challenges of bromine, pure bromine has a density of 3.1 g/cm³ and low solubility in water (3% at 25° C. at pH 7), which leads to significant stratification, which is detrimental to traditional and modern membrane-free flowing bromine designs alike. These approaches are seen to add significant cost to the zinc-bromine battery system, and complexing agents which are typically involved, can exhibit unwanted side effects such as binding with polybromide complexes (Br₃⁻,Br₅⁻, etc.) which are heavier and have lower ionic conductivity when compared to Br⁻(aq.). To address the safety and stratification issues, there is ongoing research and investment for finding suitable bromine complexing agents.

Among known approaches, implementations of the zinc-bromine battery system, wherein zinc is plated and stripped under acidic conditions on the negative electrode, and bromine is formed from or reduced to bromide ion on the positive electrode are seen to be popular. These approaches are considered a “hybrid flow battery”, which, unlike traditional flow batteries, have a fixed energy-to-power ratio due to the nature of the zinc reaction in these implementations. Although there exist several variations of the hybrid flow battery, a representative conventional implementation of a hybrid flow battery is illustrated in FIG. 1 (e.g., derived from Skyllas-Kazacos M. “Electro-chemical energy storage technologies for wind energy systems. Stand-Alone and Hybrid Wind Energy Systems”; 2010, pages 323-365).

With reference to FIG. 1, conventional hybrid flow battery system 100 formed using zinc-bromine flow cell technology is shown, with catholyte tank 102 comprising bromine (e.g., wherein the bromine phase may be complexed with a liquid such as an organic oil) and anolyte tank 104 comprising zinc. Although not explicitly shown, hybrid flow battery system 100 comprises at least one pump to move the bromine/bromide catholyte from catholyte tank 102 and to move the zinc from anolyte tank 104 into reactor 106. Reactor 106 comprises separator 110 (e.g., a membrane formed by Nafion or microporous polyethylene) to prevent anolyte/catholyte crossover. Zinc is plated and stripped on the anode, and there may or may not be a reservoir for excess zinc ion bearing solution, requiring a second pump.

It is noted that implementations of the zinc-bromine battery system without secondary reservoirs and pumps, i.e., using a single chamber for non-flowing Zn—Br₂, are less common. Such implementations use membranes or complexing agents, which were ultimately deemed responsible for the death of the battery via membrane rupture by zinc dendrites or irreversible complexing of polybromide ions.

Given the previous efforts in zinc-bromine battery implementations and considering the upcoming demands for energy storage, such as renewable-firming against wind and solar intermittency, as well as peak-shaving applications, it is recognized that aspects of the conventional implementations such as the above-noted membranes and pumps, and related connections (referred to as plumbing) add significant costs to the conventional implementations. Such costs offset the benefits of the fundamentally low-cost fuel or raw materials used in the zinc-bromine technology.

### SUMMARY

Exemplary aspects of this disclosure are directed to low cost minimal architecture zinc bromine battery (MA-ZBB) designs, wherein highly porous, hydrophobic and conductive carbon foam may be used as a bromine electrode. As elemental bromine (Br₂(l)), a nonpolar liquid, is generated during the charging cycle of the exemplary battery, the nonpolar liquid displaces polar electrolyte of the battery out of the pores of the foam electrode, which may be lossy. The foam electrode loosely traps liquid bromine within it, and prevents bromine convection during cell operation. Additionally, in this static MA-ZBB system, built for a low cost (e.g., significantly less than $100/kWhr) a self-discharge behavior of liquid bromine (Br₂(aq)) attacking dendritic zinc creeping towards the foam electrode is exploited for self-maintenance of the battery. By removing the complexing agents, pumps and membranes from the above-noted traditional zinc-bromine battery system, a predominant portion of the cost and failure points of the traditional zinc-bromine battery system are eliminated, thus supporting the feature of the minimal architecture of the exemplary. The cycle life of the exemplary battery is only limited by the irreversible degradation of carbon. The disclosed approach combines the exemplary battery design with exemplary techniques for measuring fundamental aspects of cell-level transport conditions in real-time. Accordingly, the disclosed approach provides a minimal architecture zinc-bromine battery, which satisfies the above-noted requirements for being long-lasting with low production costs, low operation and maintenance costs, and also while being scalable, thus providing solutions which are seen to have high potential for commercialization.

For example, an exemplary aspect is directed to an electrochemical energy storage device comprising a first electrode resistant to bromine, wherein the first electrode is porous and configured to generate and store liquid bromine, Br₂(l), and an electrolyte comprising zinc-bromine, ZnBr₂(aq), wherein the electrochemical energy storage device is configured to be non-flowing.

Another exemplary aspect is directed to a method of forming an electrochemical energy storage device, the method comprising forming a first electrode resistant to bromine in an electrolyte comprising zinc-bromine, ZnBr₂(aq),wherein the first electrode is porous and generates and stores liquid bromine, Br₂(l), during charging; and disposing a second electrode resistant to bromine in the electrolyte, the second electrode separated from the first electrode, wherein zinc is plated on the second electrode during charging.

Yet another exemplary aspect is directed to an apparatus comprising a zinc-bromine battery comprising a foam electrode formed in an electrolyte comprising ZnBr₂, the foam electrode configured to generate and store liquid bromine, a camera configured to obtain images of the zinc-bromine battery at two or more time instances during charge-discharge cycles of the zinc-bromine battery, and a computer configured to track distribution and transport of bromine and zinc in the zinc-bromine battery at the two or more points in time based on the images.

### BRIEF DESCRIPTION OF THE DRAWINGS

The accompanying drawings are presented to aid in the description of various aspects of the invention and are provided solely for illustration and not limitation.

FIG. 1 shows a schematic view of a conventional zinc-bromine flow battery.

FIGS. 2A-E illustrate aspects of an exemplary non-flowing zinc-bromine battery, with views of charged, discharged states thereof and images of electrodes thereof

FIG. 3 shows aspects of a charge/discharge progression for an exemplary zinc-bromine battery.

FIGS. 4A-C illustrate aspects of an exemplary apparatus for tracking transport of zinc and bromine during operation of an exemplary zinc-bromine battery, according to aspects of this disclosure.

FIG. 4D illustrates aspects of bromine ejected from a carbon foam electrode and convecting toward a zinc electrode during operation of an exemplary zinc-bromine battery, according to aspects of this disclosure.

FIGS. 5A-C illustrate aspects of calibrating concentrations of liquid bromine in an electrolyte to determine to be used in the exemplary apparatus for tracking transport of zinc and bromine in an exemplary zinc-bromine battery.

FIGS. 6A-C illustrate example aspects of an inverted battery during operation, showing a reaction zone between bromine and a zinc plated carbon foam, according to example aspects of this disclosure.

FIGS. 7A-B illustrate aspects of cycling data indicating coulombic efficiency of an exemplary zinc-bromine battery, according to example aspects of this disclosure.

FIGS. 8A-B illustrate aspects of porosity of a carbon foam correlated to volume of liquid bromine which may be stored therein for an exemplary zinc-bromine battery, according to example aspects of this disclosure.

FIGS. 9A-C illustrate aspects of analyzing an interaction between carbon and bromine of an exemplary battery using X-ray photoelectron spectroscopy (XPS) , according to example aspects of this disclosure.

FIG. 10 shows energy density and ionic resistivity of a zinc-bromine solution as a function of salt concentration.

FIG. 11 illustrates a method of forming an exemplary zinc-bromine battery.

FIG. 12 illustrates cost comparisons of exemplary zinc-bromine battery with traditional battery systems.

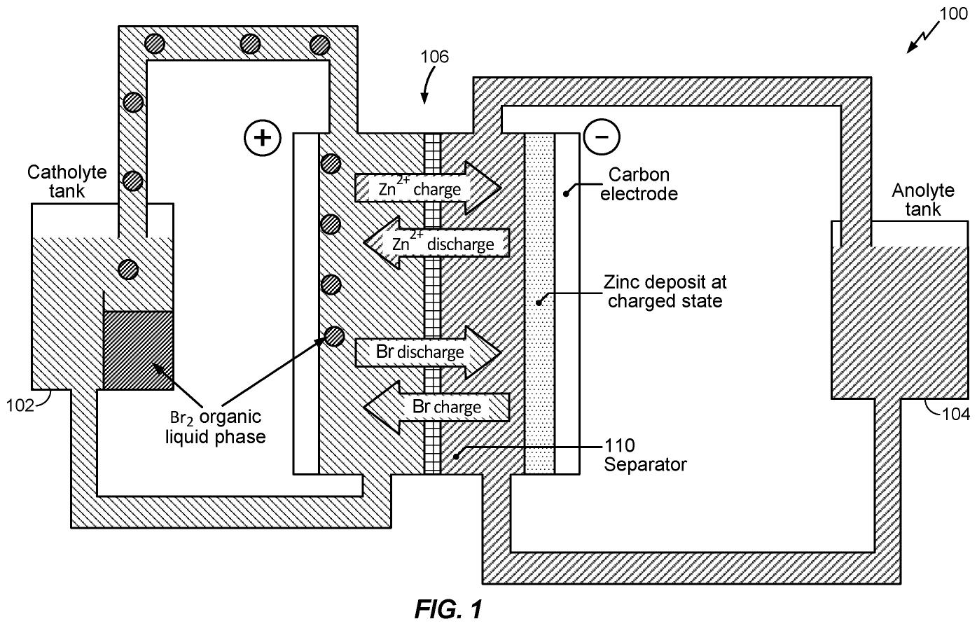

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to low cost and high efficiency electrochemical storage devices, also referred to as batteries or cells in various aspects of this disclosure. More specifically, minimal-architecture zinc-bromine battery (or MA-ZBB) designs are disclosed, which do not have a membrane.

In aspects of this disclosure, it is recognized that bromine cathodes are attractive as electrochemical oxidant storage media because they have high energy densities and rate capabilities, combined with long cycle lives. As previously noted, due to the highly corrosive nature of liquid bromine, engineering difficulties of containing and maintaining a stand-alone bromine cathode in a flow battery has prevented wider use of bromine cells in conventional approaches. However, a bromine-resistant substance such as a highly porous carbon foam electrode is provided as a first electrode, submerged in an electrolyte formed from ZnBr₂. The first electrode is configured to generate and selectively store the liquid bromine, which overcomes the above-noted difficulties in conventional approaches. A second electrode is suspended in the electrolyte (e.g., is provided in the shape of a carbon cloth) and configured to act as a zinc electrode. Exemplary zinc-bromine battery designs eliminate the need for pumps and membranes, as well as for complexing agents that are seen in the traditional zinc-bromine systems, which also eliminates accompanying costs and failure points associated with the traditional zinc-bromine systems.

In aspects of this disclosure, the following physical properties of bromine are recognized as advantageous in designing the disclosed battery system and in disclosed designs of optical sensors for tracking performance thereof:
1) The ability of bromine to adsorb to and/or intercalate in certain carbon structures;
2) The relatively high density of bromine;
3) The relatively low solubility of bromine in water; and
4) The distinct colors of the electrolyte ZnBr₂(aq), Br₂(l), and dissolved Br₂(aq), which are clear, deep red, and yellow, respectively.

In exemplary aspects, the above-noted physical characteristics of bromine are recognized, calibrated, controlled, and utilized in configuring the exemplary zinc-bromine battery which displays characteristics such as high coulombic and energy efficiencies, and a long cycle life (which may be dependent only upon the irreversible degradation of carbon).

Furthermore, in some aspects, the nature of bromine, and the exemplary battery design disclosed herein allows for the direct visualization of all bromine which leaves the carbon foam electrode. The following is possible based on tracking the color and intensity of the electrolyte during charge/discharge cycling: direct imaging and calculation of the generation and consumption of bromine in ways that support the operation of the battery (e.g., electrochemical oxidation and reduction at the cathode), as well as ways which act against the intended operation of the battery (e.g., Br₂(l/aq) interacting with Zn(s)) and engineered recombination reactions (e.g., H₂(g) recombination with Br₂(l/aq)). Additionally, the information obtained from the imaging or visual/optical tracking can be programmed as a feedback to the current source of the battery, in order to control and limit the charging of the battery to a fraction of the maximum capacity of the battery, to obtain minimal or no perceptible fading in the maximum capacity of the battery over time.

Bromine tracking can be further used to observe and analyze the flow patterns of liquid bromine during transitions between charge and discharge of the exemplary battery. Bromine convection and diffusion across the electrolyte from the foam electrode to the zinc electrode is the primary cause of self-discharge of the battery, lowering energy and current efficiencies. The flow patterns of the Br₂(l) may be analyzed, modelled, and used accordingly, in mitigating or even eliminating self-discharge of the exemplary MA-ZBB designs.

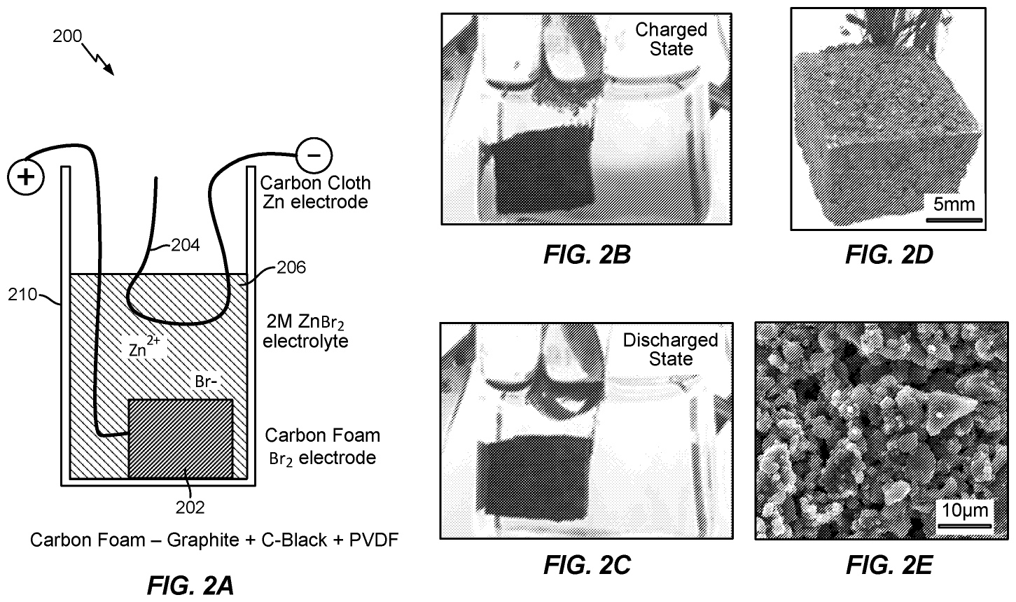

With reference to FIG. 2A, a side view of a schematic representation of an exemplary zinc-bromine battery (MA-ZBB) 200 is shown. Battery 200, as illustrated, includes holder 210 (e.g., formed of glass) in which electrolyte 206 (e.g., a 18 ml solution of 2M ZnBr₂(aq)) is disposed. A first lead (negative terminal) is shown coupled to electrode 204 (e.g., anode) formed using a carbon cloth and configured to hang on top of electrolyte 206 (e.g., with an approximately 2 cm² area exposed to the electrolyte). A second lead (positive terminal) is shown coupled to electrode 202 (e.g., cathode) formed as a foam electrode (e.g., a carbon or a fluorinated polymer such as a polyvinylidene difluoride (PVDF) foam composite), wherein the foam electrode is placed in the electrolyte, e.g., disposed at the bottom of holder 210. When battery 200 is charged, zinc is plated on the carbon cloth of electrode 204 and bromine forms in the pores of the foam electrode.

One exemplary process by which the foam electrode may be formed will now be described. A known weight ratio of graphite and carbon black (e.g., total weight=2 g) may be mixed in a solution of PVDF in N-Methyl-2-pyrrolidone or “NMP” (e.g., in a 5% by weight ratio) to create a carbon slurry. The PVDF may be used as the binder, wherein PVDF is recognized as one among a few materials that are resistant to liquid bromine corrosion. The slurry is then poured into a mold with retractable pistons (e.g., which may be formed using a 3D printer in a FormOne) and compressed (e.g., using a hydraulic press to about 1 psig pressure) to improve the carbon compaction. The mold may then be baked (e.g., placed in a vacuum oven and baked for 12 hours at 90° C.), thus evaporating the NMP and leaving behind a porous but rigid carbon foam. Porosities of over 45% are possible to achieve using the above techniques. The porosity of the foam, as well as size distribution of the foam may be tuned by altering aspects such as the composition of the slurry, hydraulic pressure, baking time, baking temperature, etc.

FIGS. 2B-C are images of an implementation of the schematic of battery 200 shown in FIG. 2A. More specifically, FIGS. 2B-C show the various components (holder 210, foam electrode 202, carbon cloth electrode 204, and electrolyte 206) of battery 200 in a discharged state and a charged state, respectively. When first formed, battery 200 is in the discharged state, as per FIG. 2B. In the discharged state, the color of electrolyte 206 is clear, identifiable as no significant shading or darkening within holder 210 in which electrolyte 206 is contained in.

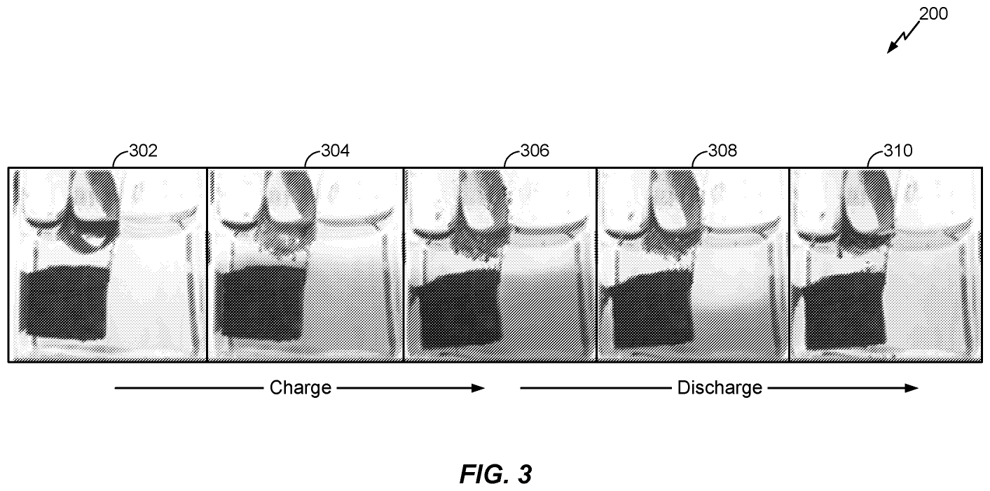

Referring to FIG. 2C, during constant current charging operation of battery 200, liquid bromine may be generated in foam electrode 202. Being hydrophobic and having an affinity to nonpolar liquids, foam electrode 202 formed of carbon foam preferentially stores the Br₂(l) within its pores, displacing the aqueous electrolyte 206. After a certain point, Br₂(l) spills out of foam electrode 202, separating due to the density and immiscibility of Br₂(l) in ZnBr₂(aq) solution. As previously mentioned, liquid Br₂ has a distinct color, dark red, identifiable with the darker shading shown in FIG. 2C for electrolyte 206 containing the liquid bromine spilled out from foam electrode 202 into electrolyte 206. Aspects directed to observing charge and discharge states of battery 202 based on the color of electrolyte 206 will be explained further with reference to FIG. 3.

During operation of battery 200, some hydrogen gas (H₂(g)) may also be formed due to corrosion of the Zn metal in acid, and some Zn(s) is consumed by the dissolved Br₂(aq) species (which may be yellow in color, above the Br₂(l)). In an ideal case, the generated H₂(g) would recombine with the Br₂ as well. Thus, the desired reactions occurring within battery 200 are:

Zn²⁺(aq)+2e↔Zn(s); and {1}

2Br⁻(aq)↔2e⁻+Br₂(l); {2}

with the potential and undesirable side reactions of:

Zn(s)+2H⁺(aq)→Zn²⁺(aq)+H₂(g); {3}

2H⁺(aq)+2e⁻→H₂(g); and {4}

Zn(s)+Br₂(l or aq)+H₂O(l)→Zn²⁺(aq)+2Br⁻(aq)+H₂O(l), {5}

wherein, the following beneficial recovery of H₂(g) via recombination may be possible:

H₂(g)+Br₂(l or aq)+H₂O(l)→2H⁺(aq)+2Br⁻(aq)+H₂O(l). {6}

Thus, taken together, without irreversible consumption of the electrode materials, a reaction scheme may be implemented according to exemplary aspects, wherein any phenomena related to non-unity coulombic efficiency can be reversed.

FIG. 2D shows an image of the foam electrode showing the lossy nature of the cathode formed by the carbon/PVDF. FIG. 2E shows a scanning electron microscope (SEM) image of the cathode formed by the carbon/PVDF.

FIG. 3 illustrates distinct images 302-310 of battery 200, viewed from left-most image 302 to right-most image 310 to show progression in a cycle from charging to discharging, respectively. More specifically, distinct colors of the electrolyte, including a first color of ZnBr₂ (aq) (e.g., clear, image 302) at an initial discharged state (e.g., per FIG. 2B), progression to a darker color in image 304 to proceed to a second color of liquid Br₂ (identifiable with the darker shade representing deep red, image 306) when fully charged (e.g., per FIG. 2C). During a discharge cycle a reverse progression of the intensity and darkness of the color is observed, with image 308 showing a lighter shade than the second color in image 308, ending with a third color of dissolved Br₂(aq) (e.g., lighter shading representing yellow, image 310). Accordingly, it is seen that the color of electrolyte 206 in images 302-310 varies based on concentration of liquid bromine in electrolyte 206, wherein electrolyte 206 has at least a first color when there is no liquid bromine present at an initial discharged state of the zinc-bromine battery (e.g., image 302), a second color when liquid bromine is released into the electrolyte at a charged state of the zinc-bromine battery (e.g., image 306), and a third color when the liquid bromine is dissolved in the electrolyte at a discharged state of the zinc-bromine battery (e.g., image 310).

Thus, the nature of bromine, and the cell design disclosed herein allows for the direct visualization of all bromine which leaves the carbon foam electrode 202. By tracking the color and intensity of electrolyte 206 during charged/discharge cycling, it is possible to directly (e.g., visually or optically, using sensors or means for capturing images, such as a camera) image and calculate the generation and consumption of bromine in one or more ways, including the desirable reactions in equations {1}-{2} above, which support the operation of battery 200 (i.e. electrochemical oxidation and reduction at the cathode) as well as the undesirable reactions in equations {3}-{6} above, which act against the intended operation of the battery (i.e. the interactions of Br₂(l/aq) interacting with Zn(s)) and engineered recombination reactions (i.e. the H₂(g) recombination with Br₂(l/aq)).

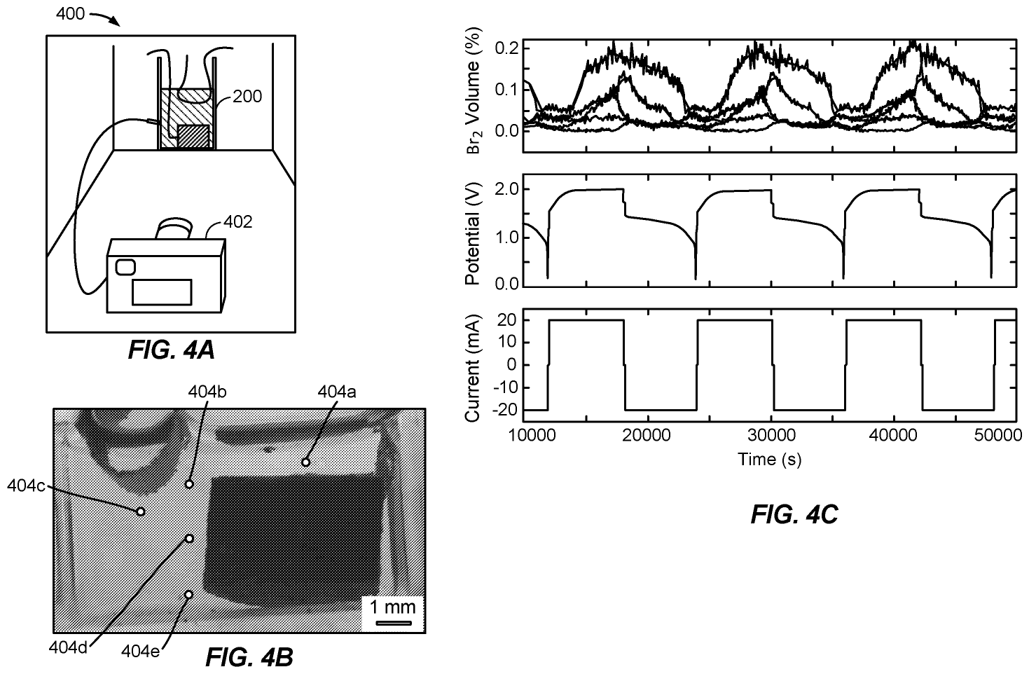

FIG. 4A illustrates an exemplary apparatus or system 400 comprising means for optically tracking charging/discharging states of a zinc-bromine battery such as battery 200. System 400 comprises camera 402 (or any other means for capturing images) placed in proximity to (e.g., disposed on a front side of) battery 200. Although not explicitly visible from FIG. 4A, system 400 may be enclosed in a lighted or illuminated box with one or more white light sources (e.g., two light sources of 50 W and 6000K color temperature) to maintain a uniform background color during operation of battery 200. Camera 402 may be configured to capture images of battery 200 at predetermined times (e.g., periodically every 10 s). Camera 402 may be configured with uniform settings across two or more charge-discharge cycles of battery 200 or across charge-discharge cycles of two or more batteries to be studied, e.g., with settings such as a predetermined and uniform manual white light balance, aperture, shutter speed and International Standards Organization (ISO) speeds maintained across all studies. The images may be stored and analyzed in a computer (not explicitly shown) or other processing means which may be provided within or coupled to (directly or indirectly) camera 402 or configured to receive the images from camera 402. This enables the computer, for example, to perform comparisons of performance of the same battery over time or of different batteries and architectures. Tracking and analysis of bromine and zinc transport during a battery's operation may also be obtained similarly. For instance, the computer may be configured to track two or more points in the images, and based on associated colors at the two or more points, detect one or more of concentration, distribution, mobility, or diffusivity of the liquid bromine in the electrolyte at the two or more points at the two or more time instances.

The concentrations and convective flow of bromine in solution outside the foam electrode can also be used as a feedback to the charging/discharging of the battery to enable improvements in the efficiency and performance of the battery. For instance, the feedback path from the computer to the zinc-bromine battery, may be used to stop a charge cycle when the second color (from FIG. 3, image 308, for example) is detected to indicate that liquid bromine is released from the foam electrode into the electrolyte.

Referring now to FIG. 4B in greater detail, various points in an exemplary image of battery 200, for example are shown. Specifically, five points, identified with reference numerals 404a-e are shown being tracked in the image of battery 200. Correspondingly, FIG. 4C shows, as a function of run-time of the studies, the following graphs: concentration of bromine at each one of points 404a-e, potential or state of charge (SOC), and applied current. Points for tracking, such as points 404a-e can be located anywhere in the imaging of battery 200, to track corresponding concentration of bromine at those points over time. This manner of tracking specific points in the image can provide information pertaining to mobility and diffusivity of liquid bromine in the electrolyte solution.

For example, in one aspect, based on the above tracking information from FIGS. 4B-C, regarding bromine distribution in exemplary zinc-bromine batteries, the size of pores or porosity of the foam electrode for effective generation and storage of the liquid bromine and to reduce loosely bound Br₂(l) for the purpose of mitigating the need for conventional catholyte pumps may be obtained (e.g., it may be possible to determine whether a centimeter-scale or greater carbon foam electrode with nanometer and micrometer porosity can effectively generate, store, and reduce Br₂(l) in a loosely bound manner).

In another aspect, the bromine distribution and tracking points 404a-e can reveal whether zinc dendrites and ramification can be allowed to recombine with bromine, while achieving desired coulombic efficiencies (e.g., a round trip energy efficiency of 75% or greater).

In yet another aspect, the above tracking techniques can also be used to determine whether H₂(g) byproducts can be effectively recombined with Br₂(l/aq) with minimal, if any, catalyst loading through manipulations of anode and cathode placement while exploiting, rather than suppressing, Br₂(l) catholyte stratification.

In some aspects, a control scheme may be implemented wherein a charge controller can be triggered based on current-voltage (I-V) conditions. Furthermore, charging/discharging protocols may also be based on location and concentration of bromine in the exemplary batteries. In one implementation, a charging protocol may be include stopping a charging cycle immediately after the Br₂(l) is first observed (e.g., via imaging/tracking) to leave the carbon foam electrode. By implementing such a protocol, e.g., based on a feedback mechanism from the computer used for analyzing images from camera 402 of FIG. 4A, for example, to stop charging immediately after the liquid bromine is first observed to leave the foam electrode, a high coulombic efficiency may be obtained (e.g., a greater than 95% coulombic efficiency may be achieved for over a number of charge-discharge cycles, e.g., 60 cycles; furthermore, approximately 10% utilization of the Zn²⁺ and Br⁻ inventory has been observed to be sufficient for achieving such a high efficiency in some implementations).

Exemplary aspects of this disclosure are also directed to determining a desirable balance between the volumes of the electrolyte and the size of the foam electrode for optimizing utilization and efficiency of battery 200. Furthermore, as previously mentioned, at the end of the charge cycle of the battery, bromine liquid is ejected from top and sides of the carbon foam electrode and convects towards the zinc electrode, thereby “self-discharging” the battery due to zinc-bromine reaction.

Referring to FIG. 4D, an example image (e.g., as obtained using apparatus 400) is shown of an exemplary battery wherein bromine ejected from the carbon foam electrode is shown as convecting toward the zinc electrode at the end of a charge cycle. In more detail, from FIG. 4D, bromine leaving the foam electrode is observed to react with the zinc, specifically, dendrites thereof, as identified by the reference numeral 450. Aspects of this disclosure are accordingly directed to correlating the ejection and transport of bromine from the foam electrode to the electric field and the related concentration gradients, for improving the efficiency of the battery and mitigating the zinc-bromine reaction 450 for example.

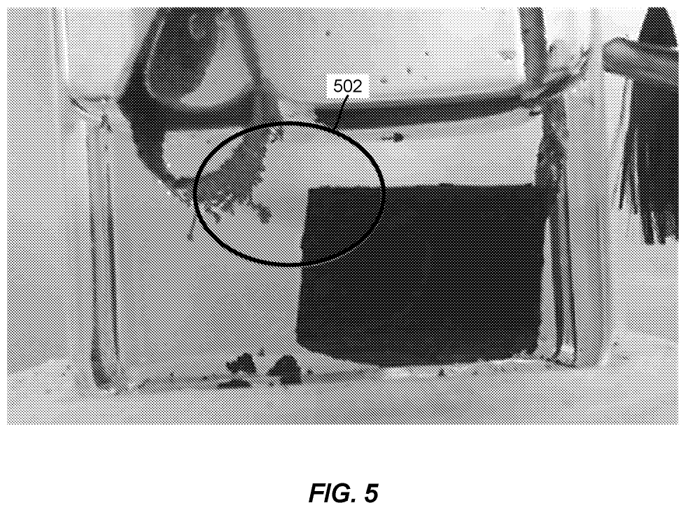

With reference now to FIGS. 5A-C, aspects of calibrating an electrolyte for use in system 400 of FIG. 4 will be discussed. FIG. 5A illustrates system 500 with a cell comprising holder 510 with varying concentrations of liquid bromine Br2(l) 512. In an setup for purely illustrative purposes with no inherent limitations based on the specific size, volume, concentrations, etc., system 500 may be configured with 5 mL Br2(l) (e.g., at a starting concentration of 10.2% by volume, as shown in image 502) in a distilled water solution and placed in a light box (e.g., similar to system 400, illuminated with two white light sources of 50 W, 6,000K color temperature, for example). The clear glass cell holder 510 may enables direct imaging of system 500. A 0.05 mL of 2M ZnBr2 salt solution may be added to the cell (e.g., using a calibrated syringe pump) periodically, (e.g., every 3 minutes) and stirred to obtain uniform concentration profiles. The light sources in the light box maintain a uniform background color. Images of the cell may be captured periodically (e.g., using a camera similar to camera 402, every 10 s with manual white light balance, aperture, shutter speed and ISO set and maintained across all experiments). Images 502, 504, 506, and 508 of four sample calibration cells are shown in with Br2(l) volumetric concentrations in solution of 10.2%, 4.8%, 1.5%, and 0.4%, respectively.

FIGS. 5B-C respectively illustrate calibration data relating the Br2(l) volume concentration to standards such as the International Commission on Illumination (CIE) X and Y color coordinates. The CIE X and Y color coordinates at each volumetric Br₂(l) concentration in FIGS. 5B-C, respectively, is obtained by averaging the red-blue-green (RGB) pixel values of a fixed 5 mm×12 mm frame of the images 502-508 obtained at each volumetric concentrations of the Br2(l) solution, and converting the RGB values to standard 1931 CIE X and Y coordinate space. Third order polynomial fits (dashed lines) are used to correlate the color of the solution to its concentration.

Optical tracking on exemplary batteries during their operation (e.g., charge-discharge cycles) may be performed by using the same light box and camera set up. The RGB values at any point in the image may be extracted and converted to CIE X & Y coordinates, which may then related to Br2(l) volumetric concentration at that point using the calibration fit, described above. This enables the comparison of different cells and architectures, as well as the tracking and analysis of bromine and zinc transport during operation.

In exemplary aspects directed to preventing the above-noted self-discharge of zinc-bromine batteries due to liquid bromine ejection from the foam electrode, the following techniques may be used. In one aspect, bromine tracking (e.g., per FIGS. 4A-C) may be used to observe, identify, and analyze the flow patterns of liquid bromine during transitions between charge and discharge of the exemplary battery. The correlation of bromine convection from the carbon foam electrode to the concentration gradients of Br₂ and Br⁻ in solution, as well as electric fields in the battery may also be determined. Further, the effects of porosity and surface morphology of the foam electrode on bromine mobility in the electrolyte solution may also be observed. In some aspects, the colors related to the self-discharge of Zn(s) when exposed to diffused aqueous bromine (e.g., yellow) may be observed and compared/contrasted with the colors related to convecting liquid bromine (e.g., red) in the battery. In yet other aspects, the effects of zinc-bromine salt concentration in the electrolyte solution and applied currents on transport of liquid bromine and resulting cell efficiency may also be studied.

In some aspects, analytical models may be constructed, of flow pattern of Br₂(l) through convection and diffusion dependent on the exemplary MA-ZBB designs, foam design and porosity, and chemical reactions at the electrodes. It is recognized that previously known mathematical models of conventional zinc-bromine flow batteries do not completely cover the static non-flow batteries of this disclosure. Thus, exemplary analytical models, in conjunction with the above-noted bromine tracking analysis are designed to provide a comprehensive and predictive analytical tool of flow fields, concentration and potential profiles, and energy efficiencies for exemplary batteries, wherein such models may be used to obtain in-depth understanding of the exemplary battery systems and also useful for scaling up and commercialization of the exemplary batteries.

As previously noted, generation of hydrogen gas (H₂(g)) at the zinc electrode is an undesirable side effect during operation of the exemplary battery in some implementations. As H₂(g) is vented out of the battery, though in very small quantities per cycle, the H₂(g) can affect the composition of the electrolyte in the long run. In order to recombine the H₂(g) with the very corrosive Br₂(l), the effect of the geometry of the exemplary battery on electrochemical performance thereof may be suitably configured. Aspects of this disclosure are directed to recapturing of the H₂(g) generated at the zinc electrode (carbon cloth) and located in the headspace by placing the bromine electrode (carbon foam electrode) in an inverted architecture (with the foam electrode on top) in order to enable the H₂(g) reaction with the stored Br₂(l).

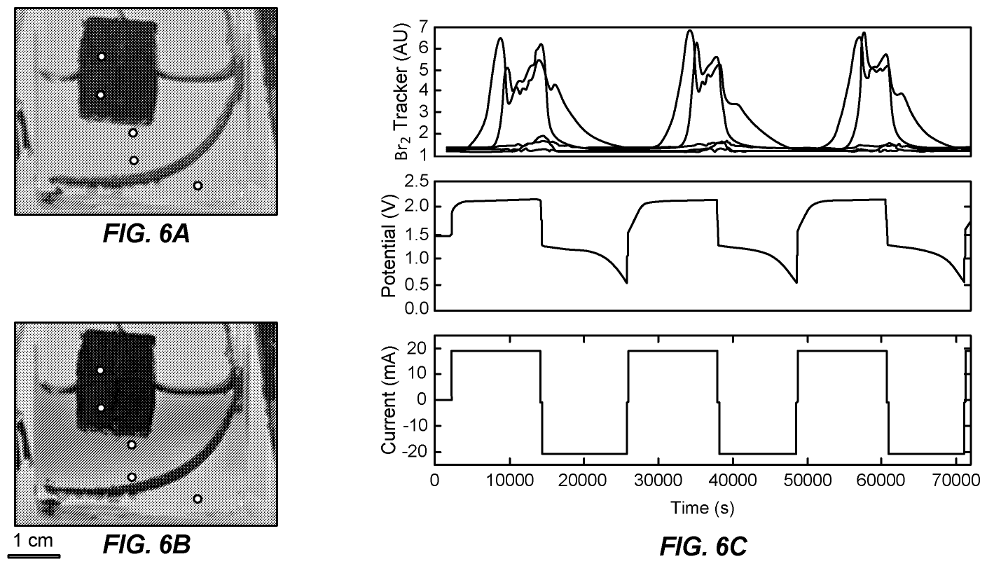

With reference now to FIG. 6A, an image of an exemplary battery designed with the inverted architecture is shown at the beginning and end of a charge cycle with five color tagged tracking points (similar to FIG. 4B). Specifically, FIG. 6A shows a partially charged inverted battery with a carbon foam electrode on top, and a zinc plated carbon cloth on the bottom. FIG. 6B shows a charged version of the inverted battery of FIG. 6A, with a clear reaction zone shown between the Br₂(aq) front and the zinc plated carbon foam (with no visible evidence of Br₂(l) under the carbon cloth). FIG. 6C shows the positional bromine intensity at these five points alongside voltage (potential) and current, each of these plotted as a function of runtime. Using the information from FIGS. 6A-C, H₂(g) bubbling up from the bottom can potentially be reacted with the Br₂(l) on top under the right condition (through photocatalysis or in the presence of a hydrogen catalyst) to form and re-dissolve HBr back into the electrolyte solution.

In some implementations of graphite as a part of the carbon foam electrode may potentially lead to exfoliation of graphite into sheets of graphene under extended exposure to liquid bromine, thus compromising the structural integrity of the carbon foam electrode. To overcome this potentially undesirable effect, other carbon types including activated carbon, charcoal, pyrolyzed suger, etc., may be used as alternative or additional components in the fabrication of the carbon foam electrode.

In this disclosure, it is recognized that a significant proportion of the coulombic losses that may occur in exemplary zinc-bromine batteries may be due to Zn(s) and Br₂(l) recombination or the above-noted self-discharge 450 of FIG. 4D; or due to the H₂(g) recombination being fast enough to prevent significant pressure build up. Exemplary aspects are directed to mitigating the side reactions and recovering the coulombic losses based on the above recognition.

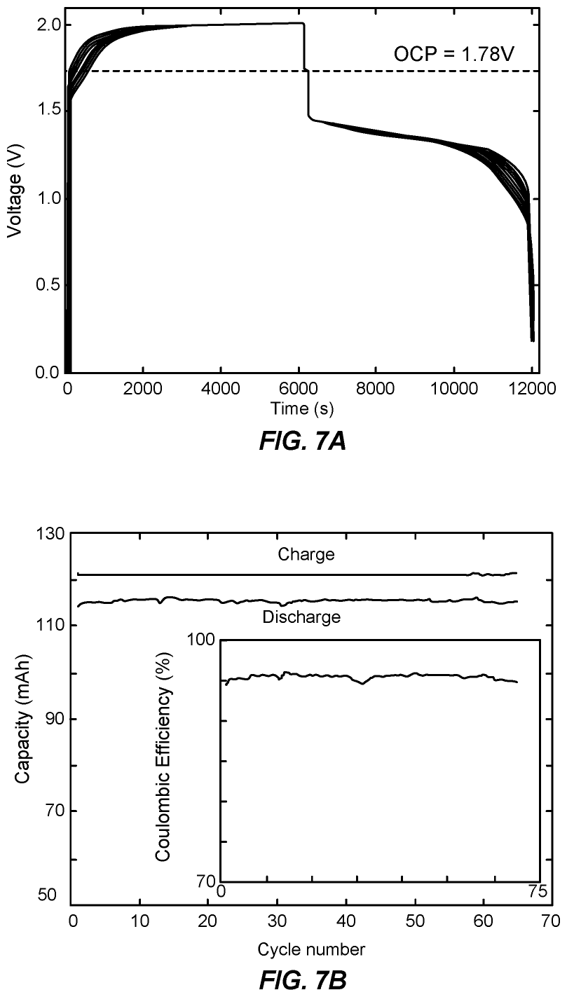

In FIGS. 7A-B, example charge/discharge cycling data is shown, indicating 90% coulombic efficiency at C/2 rates in FIG. 7A, overlaid with a graph of voltage (potential) vs. time for 30 cycles at C/2 charge C/2 discharge rates. FIG. 7B shows a graph of capacity and efficiency of an exemplary battery as a function of cycle time. From FIG. 7B it is seen that over 95% coulombic efficiency may be achieved at a C/2 discharge (on 4 hour full charge basis) for over 100 cycles, in a sealed cell with no more than a 1 psig increase in pressure.

Further, in some aspects, based on examining the geometric and material components of the battery, improvements may be made, such as implementing a non-optically interrogatable teflon/glass design, which may be well-suited for scaling up manufacturing of the battery. The spacing between the carbon cloth electrode and carbon foam electrode contributes to the cell resistance, and accordingly, this distance may be balanced and scaled to achieve the lowest cell resistance while avoiding or preventing soft shorts which may occur due to zinc dendrite growth towards the carbon foam electrode that can result in the zinc dendrite making contact with the carbon foam electrode.

The volume of bromine stored in the carbon foam electrode is also understood to depend on properties of the foam electrode based on the composition thereof, wherein the properties may include, the type of carbon used (activated carbon, graphite, carbon black, graphene, etc.), the composition of the foam (ratios of the different carbon types), size/dimensions of the carbon foam (size of the mold), and the porosity and pore size distribution (depending on NMP solvent evaporation rate). Accordingly, aspects of this disclosure are directed to controlling and adjusting these properties with a view to improving the volumetric capacity of Br₂(l) stored in the foam electrode, which in turn increases charge/discharge cycle times of the exemplary zinc-bromine batteries and enables maximum energy and current efficiencies.

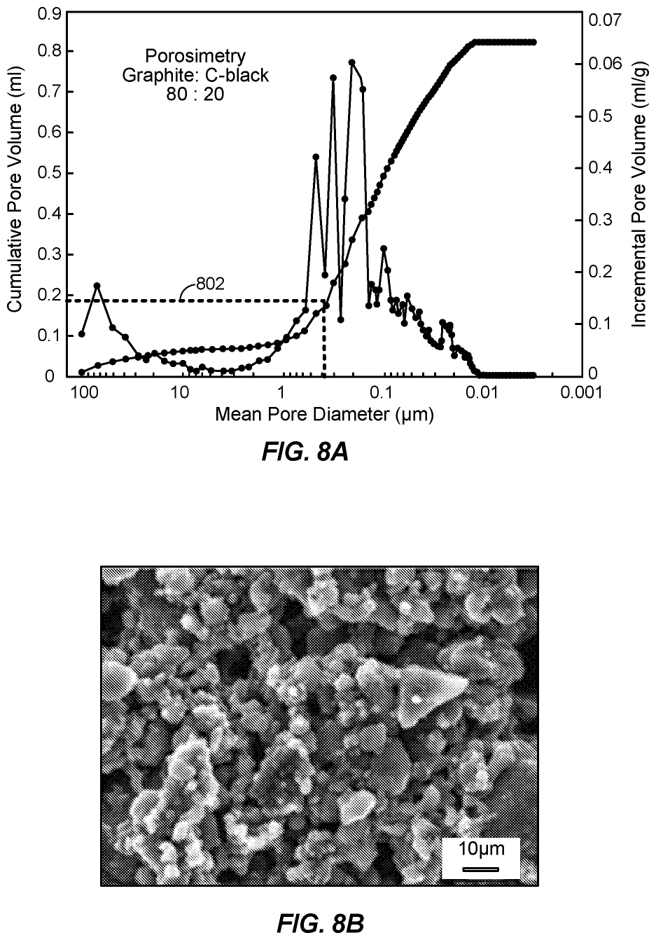

With reference now to FIGS. 8A-B, aspects of correlating the volume of Br₂(l) stored in the foam electrode to the porosity of the foam electrode will be discussed. In aspects of this disclosure, the porosity of the foam electrode and the volume of Br₂(l) stored therein may be measured by techniques such as, mercury porosimetry, vacuum saturation, bromine tracking, SEM, etc. Mercury porosimetry provides the cumulative volume (in ml/g) available at each mean pore diameter in the foam electrode as well as the total porosity (in volume %), as shown in FIG. 8A. The analysis also yields the pore size distribution. Techniques such as vacuum saturation may be used to validate the mercury porometry results and determine the total volume of Br₂(l) capable of occupying the pores of a particular foam composition. In the example plot shown in FIG. 8A, mercury porosimetry of an example carbon foam electrode (with 80/20 graphite/carbon-black composition) shows a cumulative volume (in ml) as a function of mean pore diameter (um), which provides an indication of the cumulative available for Br₂(l) down to each mean pore diameter as well as the pore size distribution. Optical bromine tracking yields volume of liquid bromine stored in the foam electrode during operation of the battery. The dotted line 802 indicates the minimum diameter pore that Br₂(l) can penetrate in this particular foam electrode.

FIG. 8B shows an SEM image analysis of an exemplary foam electrode's cross-section, which may be used to see the location of the pores of various diameter in the foam (whether larger pores are on the outer edges or uniformly distributed throughout the cross section). Further, the bromine tracking, described above, can be used to visually determine the point in time at which Br₂(l) spills out of the foam electrode during constant current charging operation of the battery. The current ((mA)×time (s)) is equal to the total charge (in coulombs) passed up to that point. The total number of electrons pulled out of the foam electrode may be determined as (# of e⁻)/2, which is the moles of Br₂(l) generated and stored in the foam electrode. The volume of bromine stored in the foam electrode, optically determined, can be mapped on to the cumulative pore volume plot obtained through porosimetry, as shown with the dashed line 702 in FIG. 8A. Thus the smallest diameter pore that can be penetrated by liquid bromine (Br₂(l)) can be determined, before surface tension prevents any further occupation.

Accordingly, by controlling the pore size and distribution of the foam electrode based on solvent evaporation rate or by adding SiO₂ nanoparticles as spacers during fabrication of the foam electrode, in exemplary aspects, the volume of captured bromine per gram of the foam electrode can be further increased. Increasing the volume of the captured or stored bromine in the foam electrode improves the maximum capacity of the battery, e.g., by rates of C/5 to C/8.

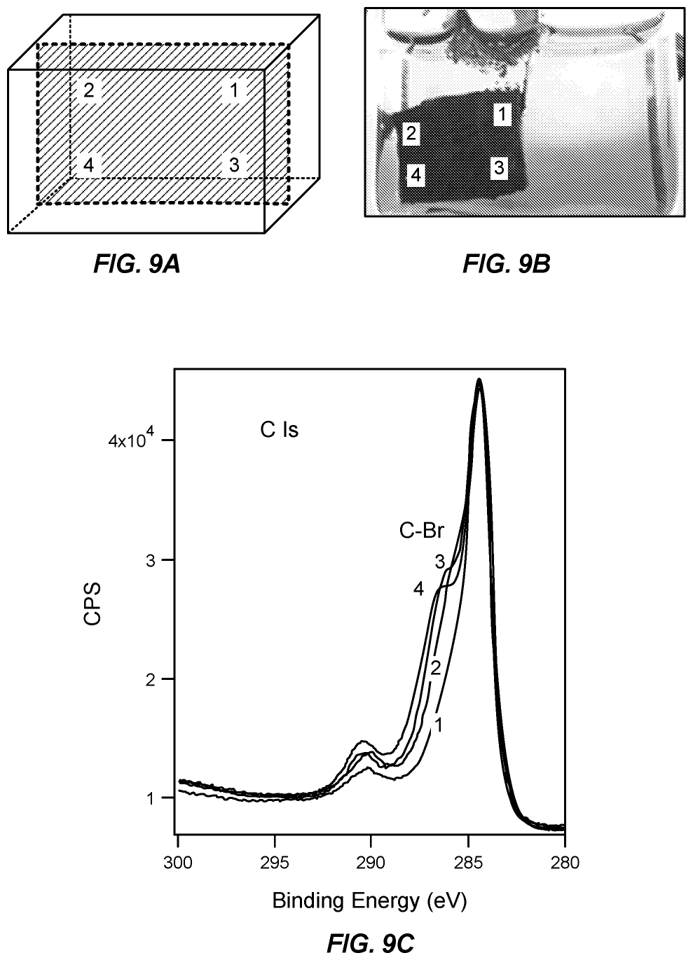

With reference to FIGS. 9A-C, aspects of analyzing an interaction between carbon and bromine after multiple charge/discharge cycles of an exemplary battery will be discussed. The interaction between carbon and bromine may be determined using techniques such as X-ray photoelectron spectroscopy (XPS). For example, FIG. 9A, shows a schematic of cross section of a foam electrode, with points labeled 1, 2, 3, and 4, at which an XPS analysis is performed. FIG. 9B illustrates a corresponding image of a foam electrode used for XPS analysis, with the respective points 1-4 labeled therein. As previously mentioned, liquid bromine is highly corrosive and is known to interact with graphite through intercalation and chemical bonding, which can lead to damage of the carbon foam electrode and reduce its effectiveness as an electrode. The XPS analysis may reveal a detailed report on the health of the carbon foam electrode as a function of or correlated to a number of charge/discharge cycles, as well as physical location within the battery.

Since Br₂(l) is dense and gravity pulls it down, a greater corrosion damage may manifest towards the bottom of the foam electrode, rather than the top, after multiple cycles. Accordingly, as shown in FIG. 9C, carbon-bromine (C—Br) interaction analysis of the four points 1-4 based on the XPS analyses thereof, reveals that more Br₂ corrosion occurs towards the bottom of the foam electrode where liquid-bromine (Br₂(l)) is stored for longer periods during operation of the battery.

As such, exemplary aspects of this disclosure are also directed to designs of the disclosed MA-ZBB designs which improve performance thereof. Referring back to FIG. 2A, an exemplary zinc-bromine battery 200 may comprise the components identified as holder 210 (e.g., a glass holder), foam electrode 202 (e.g., carbon foam electrode for storing bromine), electrode 204 (e.g., formed with a carbon cloth to form the zinc electrode) and electrolyte 206 (e.g., aqueous ZnBr₂ solution electrolyte). As discussed with reference to FIG. 4A, battery 200 may be placed in a white light box (e.g., with two white light sources) and camera 402 to image battery 200 during operation. The leads from electrodes 202 and 204 (e.g., FIG. 2A) may be connected to a constant current supply source to monitor the potential and resistance of battery 200 during operation. Further, the pressure and temperature of battery 200 may also be monitored to provide a comprehensive analysis of battery 200 during operation.

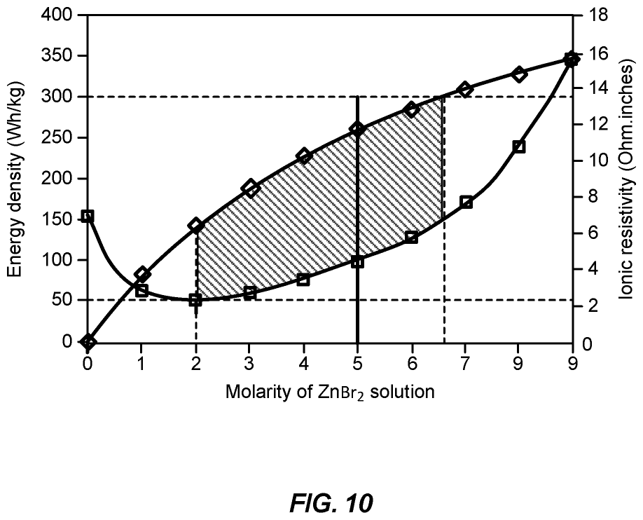

With reference now to FIG. 10, a plot of energy density and ionic resistivity of the electrolyte comprising a ZnBr₂ solution as a function of salt concentration is shown based on the above analyses performed on batteries formed with a 2M ZnBr₂ electrolyte. The molarity of the electrolyte in the example of FIG. 10 represents the highest ionic conductivity of the electrolyte (e.g., based on U.S. Pat. No. 4,482,614 to A Zito R Jr., “Zinc-bromine battery with long term stability”). Higher energy densities may be attainable at higher electrolyte molalities, but at the cost of ionic conductivity. It is recognized that introducing secondary salts, like NaCl, ZnCl₂ or CaBr₂, may increase the transference number of the battery, thus helping with performance.

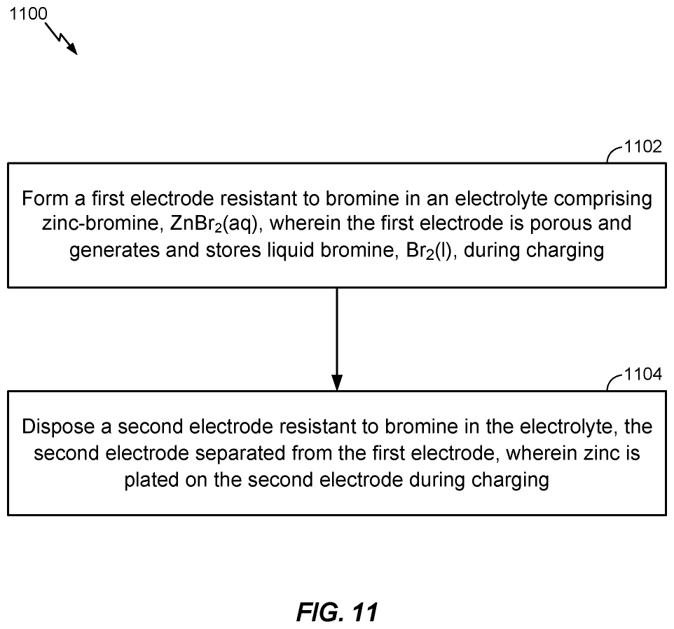

It will be appreciated that aspects include various methods for performing the processes, functions and/or algorithms disclosed herein. For example, FIG. 11 illustrates an exemplary method 1100 of forming an electrochemical energy storage device (e.g., zinc-bromine battery 200).

Step 1102 comprises forming a first electrode (e.g., a carbon foam bromine electrode 202) resistant to bromine in an electrolyte comprising zinc-bromine (e.g., ZnBr₂(aq) electrolyte 206), wherein the first electrode is porous and generates and stores liquid bromine, Br₂(l), during charging.

Step 1104 comprises disposing a second electrode resistant to bromine (e.g., carbon cloth zinc electrode 204) in the electrolyte, the second electrode separated from the first electrode, wherein zinc is plated on the second electrode during charging.

With reference now to FIG. 12, example costs estimated for MA-ZBB implementations in experimental or laboratory settings based on presently known market prices for component materials is illustrated. It will be understood that the representations in FIG. 12 are merely for the purposes of illustrating the cost benefits of the exemplary MA-ZBB designs and not to be construed as inherent limitations of any systems or designs within the scope of this disclosure. In more detail, table 1200 of FIG. 12 shows estimates of the current and projected system costs of $176/kWh and $94/kWh MA-ZBB systems, respectively, which only includes costs for materials, but not ancillary design and manufacturing costs, such as those pertaining to transportation, overhead, or labor costs, for example.

The levelized costs of electricity (LCOES) for the exemplary MA-ZBB designs is defined as $/kWh over its lifetime (number of cycles) and energy efficiency. The LCOES of the projected MA-ZBB is shown in row 1212 of table 1200, which is calculated as $94/kWh/0.6 energy efficiency/1,000 cycles, and shown as $0.159/kWh/cycle. The range of projected LCOES for the same design is obtained by changing 1000 cycles to 8,000-10,000 cycles, keeping the $/kWh and the energy efficiency the same. The LCOES breakdown of other commonly used and commercially available battery systems like traditional lead acid, lithium ion, sodium sulphide, vanadium and Zn—Br redox flow batteries (RFB) is similarly calculated and shown in rows 1202-1210 for comparison with the LCOES of MA-ZBB designs of row 1212. As can be appreciated, the LCOES for the MA-ZBB designs are significantly (e.g., one or more orders of magnitude) lower than the remaining alternatives. These comparisons reveal the exemplary benefits that may be realized even with the experimental implementations. Accordingly, with more efficient manufacturing taken into account when the exemplary designs are scaled up for production in commercial settings, the benefits are projected to be even more significant.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium.

Accordingly, an aspect of the invention can include a computer-readable media embodying a method for making and using membrane-free minimal architecture zinc bromine battery (MA-ZBB) with bromine-trapping composite carbon foam electrode. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. An electrochemical energy storage device comprising:
a first electrode resistant to bromine, wherein the first electrode is porous and configured to generate and store liquid bromine, Br₂(l); and
an electrolyte comprising zinc-bromine, ZnBr₂(aq), wherein the electrochemical energy storage device is configured to be non-flowing.

2. The electrochemical energy storage device of claim 1, further comprises a second electrode resistant to bromine, the second electrode disposed in the electrolyte and separated from the first electrode.

3. The electrochemical energy storage device of claim 2, wherein the second electrode disposed is separated from the first electrode at a distance, wherein the distance is determined based on reducing resistance of the electrochemical energy storage device and preventing zinc dendrite growth on the second electrode from contacting the first electrode.

4. The electrochemical energy storage device of claim 2, wherein during a charge cycle of the electrochemical energy storage device, zinc is plated on the second electrode and bromine is generated in pores of the first electrode.

5. The electrochemical energy storage device of claim 1, wherein the first electrode comprises a carbon foam or fluorinated polymer, and wherein the second electrode comprises a carbon cloth.

6. The electrochemical energy storage device of claim 1, wherein hydrogen gas, H2(g) is formed due to corrosion of zinc plated on the second electrode, and wherein the electrochemical energy storage device is disposed in an inverted architecture configured to recombine the hydrogen gas with the liquid bromine, wherein the inverted architecture comprises the first electrode disposed on a top portion of a holder and the second electrode disposed on a bottom portion of the holder, and wherein the hydrogen gas bubbling up from the second electrode is configured to react with the liquid bromine generated in the first electrode and dissolve in the electrolyte.

7. The electrochemical energy storage device of claim 1, wherein charge and discharge cycle times of the electrochemical energy storage device are based on a volume of liquid bromine stored in the first electrode, and wherein one of more properties of the first electrode are adjusted to increase the volume of the liquid bromine stored therein, wherein the one or more properties include one or more of a material composition, size, dimensions, porosity, or pore size distribution.

8. The electrochemical energy storage device of claim 7, wherein the volume of the liquid bromine is further controlled based on addition of nanoparticles to the first electrode.

9. The electrochemical energy storage device of claim 1, wherein the electrolyte further comprises a secondary salt.

10. A method of forming an electrochemical energy storage device, the method comprising:
forming a first electrode resistant to bromine in an electrolyte comprising zinc-bromine, ZnBr₂(aq),wherein the first electrode is porous and generates and stores liquid bromine, Br₂(l), during charging; and
disposing a second electrode resistant to bromine in the electrolyte, the second electrode separated from the first electrode, wherein zinc is plated on the second electrode during charging.

11. The method of claim 10, wherein the first electrode comprises a carbon foam, and wherein forming the first electrode comprises:
mixing graphite and carbon black of a predetermined weight ratio in a solution of a fluorinated polymer in N-Methyl-2-pyrrolidone, NMP, to create a carbon slurry;
pouring the carbon slurry into a mold with retractable pistons;
compressing the mold with a hydraulic press;
baking the mold; and
evaporating the NMP to form the carbon foam.

12. The method of claim 11, comprising adjusting one or more of a porosity or size distribution of the carbon foam based on tuning one or more of a composition of the slurry, pressure of the hydraulic press, time for baking the mold, or temperature of baking the mold.

13. The method of claim 10, further comprising performing a porosimetry analysis on the first electrode to determine a cumulative volume of the liquid bromine in the first electrode as a function of porosity or pore size of the first electrode.

14. The method of claim 10, further comprising performing a X-ray photoelectron spectroscopy (XPS) analysis on the first electrode to obtain images of the first electrode at two or more points of the first electrode during operation of the zinc-bromine battery.

15. The method of claim 14, further comprising detecting corrosion of the first electrode due to corrosion caused by liquid bromine at the two or more points from the images.

16. An apparatus comprising:
a zinc-bromine battery comprising a foam electrode formed in an electrolyte comprising ZnBr₂, the foam electrode configured to generate and store liquid bromine;
a camera configured to obtain images of the zinc-bromine battery at two or more time instances during charge-discharge cycles of the zinc-bromine battery; and
a computer configured to track distribution and transport of bromine and zinc in the zinc-bromine battery at the two or more points in time based on the images.

17. The apparatus of claim 16, wherein a color of the electrolyte in the images varies based on concentration of liquid bromine in the electrolyte, wherein the electrolyte has at least a first color when there is no liquid bromine present at an initial discharged state of the zinc-bromine battery, a second color when liquid bromine is released into the electrolyte at a charged state of the zinc-bromine battery, and a third color when the liquid bromine is dissolved in the electrolyte at a discharged state of the zinc-bromine battery.

18. The apparatus of claim 17, wherein the computer is configured to track two or more points in the images, and based on associated colors at the two or more points, detect one or more of concentration, distribution, mobility, or diffusivity of the liquid bromine in the electrolyte at the two or more points at the two or more time instances.

19. The apparatus of claim 18, further comprising a feedback path from the computer to the zinc-bromine battery, configured to stop a charge cycle when the second color is detected to indicate that liquid bromine is released from the foam electrode into the electrolyte.

20. The apparatus of claim 16, further comprising a light source configured to maintain a uniform background color of the zinc-bromine battery.
